(19) United States
(12) Patent Application Publication
(10) Pub. No.: US 2009/0265695 A1
(43) Pub. Date: Oct. 22, 2009

(54) METHOD AND APPARATUS FOR ANALYZING PROGRAM EXECUTION PATH

(75) Inventor: Shuichi KARINO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/423,446

(22) Filed: Apr. 14, 2009

(30) Foreign Application Priority Data
Apr. 18, 2008 (JP) 2008-108954

(51) Int. Cl. G06F 9/44

(52) U.S. Cl. 717/131

(57) ABSTRACT

An apparatus that analyzes execution paths of a target program includes a setting unit, a detecting unit, a determining unit, and a plurality of buffers. The setting unit stores a condition for determining whether or not to record events caused by execution of the target program. The detecting unit detects input and output data and events which are caused by execution of the target program. The determining unit determines whether or not to record the events based on the condition. The plurality of buffers store the events correlated with the input and output data if the determining unit determines to record the events.

### BACKGROUND OF THE INVENTION

1. Field of the Invention

The present invention relates to technologies of analyzing execution paths of specific data processed by communication software.

Priority is claimed on Japanese Patent Application No. 2008-108954, filed Apr. 18, 2008, the content of which is incorporated herein by reference.

2. Description of the Related Art

Conventionally, technologies of analyzing program execution paths have been proposed for analyzing causes of program malfunctions or collecting information for performance optimization (see, for example, Japanese Unexamined Patent Application, Fast Publication Nos. 2002-078200 and 2007-328597).

One method of analyzing software execution paths in a communication device is explained hereinafter. In general, software includes data and programs, and a command (probe) is inserted into a certain position of a program so that an event caused upon executing the command is recorded. Hereinafter, the process of recording an event upon executing a program is called “execution probe”.

A probe is inserted into a program at a position targeted for recording, execution records are collected by executing the program, and thereby execution paths are analyzed based on the execution records. Information to be recorded by the probe typically includes, for example, a position in a source code, the execution time specified by a clock or a clock cycle counter of a CPU (Central Processing Unit), and the value of an important parameter.

As the most primitive means, “printf( )” implements a probe by, for example, displaying execution records on a system console or recording events in the system log. Since printf includes conversion into character strings which causes high execution costs, a buffer for recording is provided in an advanced analysis method so that recorded data is stored in the buffer and read out after execution of a program, thereby efficiently implementing the probe.

If a probe process is complicated, the following methods are used. The first one is to directly insert a command into a target program at a recording point and execute the command. The second one is to prepare an execution probe as a subroutine and insert a code to invoke the subroutine into a target program at a recording point. The third one is to transfer control to a subroutine without changing a target program using debugging (such as a break point) of a CPU.

Execution records in the above methods have the following formats.

Identifier 1 of execution point: execution record information 1 (such as a value of a time or a parameter)

Identifier 2 of execution point: execution record information 2 (such as a value of a time or a parameter)

A stack trace is a method of efficiently collecting execution records by a few execution probes. If one routine calls another routine, an argument, a return address, or the like is stacked according to the order of nests of a call command. If these pieces of information are recorded in an execution probe, execution records by routines not including an execution probe, such as a call flow or an argument, can also be obtained.

If information to be recorded differs at each execution point, different subroutines of an execution probe may be used. If the same information is to be recorded at each execution point, a single subroutine may be shared.

Here, these execution path analysis methods are assumed to be applied to communication software. Generally, communication software is implemented as a program for transmitting and receiving data between an application program and an opposing device through a transmission path based on a given protocol. In current communication software, such as TCP/IP, multiple protocols are conceptually stacked in layers, as shown in FIG. 14. In other words, an Ethernet (registered trademark) driver 1, a Firewire driver 2, a PPP driver 3, and a Loopback driver 4 are included in the lowest layer. A network interface 5, an ARP 6, an IPv4 7, an IPv6 8, an ICMPv4 9, a UDP 10, a TCP 11, an ICMPv6 12, a socket API 13, an application 14, and the like are included in the higher layers.

FIG. 15 illustrates a TCP/IP stack in BSD/OS as a more specific example. The configuration of UDP reception processing is shown between dashed lines. Communication data passes through programs of IPv4, UDP, and Socket API between a transmission path and an application.

In analysis of communication processing, a function of a specific protocol is focused in some case, and specific communication data is focused in another case. For example, a source of transmission delay can be found by analyzing when and by which module data included in a specific received packet is processed.

However, the conventional execution path analysis methods have the following problems.

Execution records of non-targeted data occur when the non-targeted data is processed by a probe. Accordingly, information concerning which data is currently processed has to be recorded point by point to obtain execution records of the targeted data, thereby causing higher costs for generating a program for the recording. If targeted data is encoded, it is impossible to identify whether or not the encoded data is targeted data, later.

Here, the following conditions of target data are assumed. The number of the transport protocol is assumed to be 6 (TCP). The destination port number of the transport protocol is assumed to be 5013. The destination IP address is assumed to be 192.168.1.15. The processing requirements for the Network Layer are assumed that ESP encapsulation is executed and a destination IP address of an outer header is 133.201.5.15.

Only the data satisfying these conditions is targeted for an execution path analysis. However, whether or not a reception packet satisfies the conditions cannot be determined in, for example, an IP reception process since ESP encapsulation has to be performed on every packet and conditions of the encapsulated packet are specified.

In this case, only the conditions that ESP encapsulation is executed and the destination IP address of an outer header is 133.201.5.15 can be determined. Accordingly, execution records of packets satisfying the conditions have to always be stored by execution probes.

Additionally, execution records are stored in case it is difficult to determine upon an execution probe whether or not the processing is executed for target data. Execution records are stored in, for example, a system log or a buffer. If execution records are stored in a system log and data to be processed increases, outputs from the system log and the amount of processing such as displaying or recording increases, thereby degrading performance of other processing.

On the other hand, if execution records are stored in a buffer, recoding costs are occasionally low since data is recoded in high-speed memory or the like. However, all data cannot occasionally be stored in the buffer due to the great amount of data. In this case, data has to intermittently be read from the buffer and stored in another storage device, and therefore the processing amount of the extra work is not negligible. For these reasons, the performance of recording degrades due to a load of the extra work, thereby causing operation malfunction. In this case, execution records cannot be stored.

Further, protocol processing is usually event-driven and multithreaded. In other words, processing commences with reception of a packet, a timeout of a timer, or the like as a trigger. Processing commenced with another trigger is independently executed. Even in the case of single data processing, data is stored in a buffer after protocol processing is executed with reception of a packet as a trigger, followed by another process driven by a timer in some cases. In this case, different threads run for respective events, and therefore stacks also differ for respective events. Consequently, only execution records for a targeted event can be obtained from stacks by an execution probe, and a series of sequential execution records cannot be obtained in some cases.

For example, it is assumed that there is a program as shown in FIG. 16. The program includes routines 1 to 4, each of which processes data d. The routine 1 calls the routine 2. The routine 3 calls the routine 4. The routine 2 terminates processing on data. If a certain condition is satisfied, a scheduler calls the routine 3 and continues processing on the same data.

FIG. 17 is a sequence of this process illustrating the state of a stack which changes according to routine calls as time elapses. In this case, only the following stack trace can be obtained even if a probe is inserted into the routine 4.

(start of stack)
routine 4
routine 3
scheduler
(end of stack)

Since data is actually processed by the routine 2 and the routine 1 before the scheduler, all execution paths cannot be traced. Thus, the conventional execution path analyzing methods using the conventional execution probes cannot effectively record execution paths of specific data, causing significant problems on software developments and performance optimization.

### SUMMARY OF THE INVENTION

The present invention is made in consideration of the above situations.

To solve the above problems, there is provided an apparatus that analyzes execution paths of a target program. The apparatus includes a setting unit, a detecting unit, a determining unit, and a plurality of buffers. The setting unit stores a condition for determining whether or not to record events caused by execution of the target program. The detecting unit detects input and output data and events which are caused by execution of the target program. The determining unit determines whether or not to record the events based on the condition. The plurality of buffers store the events correlated with the input and output data if the determining unit determines to record the events.

In another embodiment, there is provided a method of analyzing execution paths of a target program. The method includes the following processes. A condition for determining whether or not to record events caused by execution of the target program is stored. Then, input and output data and events which are caused by execution of the target program are detected. Then, whether or not to record the events is determined based on the condition. Then, the events correlated with the input and output data are stored into a plurality of buffers if it is determined to record the events.

According to the present invention, execution paths of specific data can selectively be recorded and read. Additionally, only necessary execution records for desired processing data can be stored. Further, execution records for divided processing data can distinguishably be stored. Moreover, input and output data can efficiently be connected since transfer of data causing degradation of memory efficiency is not executed.

### BRIEF DESCRIPTION OF THE DRAWINGS

The above features and advantages of the present invention will be more apparent from the following description of certain preferred embodiments taken in conjunction with the accompanying drawings, wherein:

FIG. 1 is a block diagram of an execution path analyzing system according to a first embodiment of the present invention;

FIGS. 2 and 3 illustrate examples of data buffers used in a communication device according to the first embodiment;

FIGS. 4 and 5 are flowcharts illustrating operations by an execution probe according to the first embodiment;

FIG. 6 illustrates an example of execution record data;

FIG. 7 illustrates an operation of providing a record region according to the first embodiment;

FIGS. 8 and 9 illustrate an operation of providing a free region according to the first embodiment;

FIG. 10 illustrates an operation of connecting processing data according to a third embodiment;

FIGS. 11 and 12 illustrate operations when processing data are connected according to the third embodiment;

FIG. 13 illustrates an operation after processing data are connected according to the third embodiment;

FIG. 14 is a block diagram illustrating the configuration of software included in a general communication device;

FIG. 15 is a block diagram illustrating the configuration of a TCP/IP stack in BSD/OS related to UDP reception processing;

FIG. 16 illustrates an example of a program; and

FIG. 17 illustrates the varying state of a stack in communication software.

### DETAILED DESCRIPTION OF THE INVENTION

The invention will now be described herein with reference to illustrative embodiments. Those skilled in the art will recognize that many alternative embodiments can be accomplished using the teachings of the present invention and that the invention is not limited to the embodiments illustrated herein for explanatory purposes.

### First Embodiment

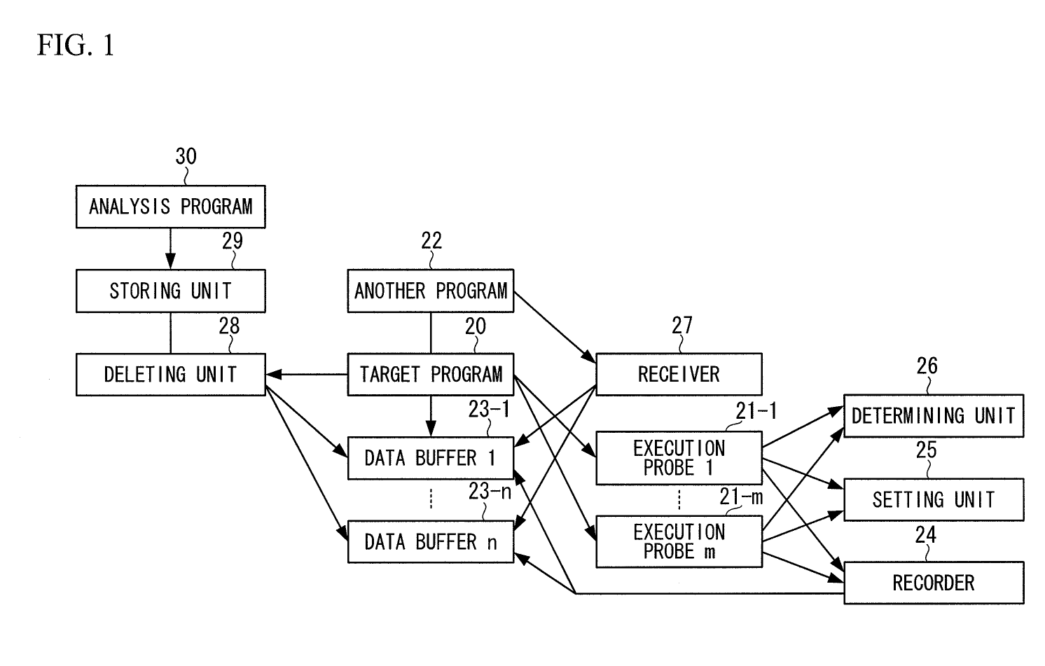

FIG. 1 is a block diagram illustrating the configuration of an execution path analyzing system according to a first embodiment. The execution path analyzing system includes a target program 20 targeted for recording execution paths, execution probes 21-1 to 21-m, another program 22, data buffers 23-1 to 23-n that store data, a recorder 24, a setting unit 25, a determining unit 26, a receiver 27, a deleting unit 28, a storage 29, and an analysis program 30.

The other program 22 typically includes, for example, an application program and an OS device driver. The target program 20 receives processing data from the other program 22, executes given processing on the processing data, and deletes the processed data or outputs the processed data to the other program 22.

The execution probes 21-1 to 21-m detect execution of a specific command included in the target program and executes a given processing. Upon executing the given processing, the execution probes 21-1 to 21-m can identify the position of the detected command in the target program 20, a position of a memory storing data currently processed by the detected command, values of parameters at the position of the detected command which can be referred to in the target program. Generally, these pieces of information are received as argument data if the execution probes 21-1 to 21-m are implemented as functions. Hereinafter, the execution probes 21-1 to 21-m are collectively called the execution probe 21.

The data buffers 23-1 to 23-n store processing data processed by the target program 20. Although it is assumed that the amount of processing data is finite for the simplicity of explanation, the amount of processing data is not always finite since data to be processed changes as time elapses. Since the number of the data buffers 23-1 to 23-n is finite, at most n data buffers are always used. If the amount of data is not important, an explanation will be given with respect to only one piece of data.

Processing data is stored in one or more data buffers. The data buffers 23-1 to 23-n have a fixed length and include a data region and a data management region. The data management region includes at least an address of a data buffer storing subsequent data (identifier of the buffer if there is no subsequent data), the type of data stored in the data buffer, a start position of data stored in the data buffer, and the amount of data stored in the data buffer. Hereinafter, the data buffers 23-1 to 23-n are collectively called the data buffer 23.

The recorder 24 writes execution records at given positions of the data buffers 23-1 to 23-n based on commands from the execution probes 21-1 to 21-m. The setting unit 25 determines the type of data to be recorded as execution records by a user operation. The determining unit 26 determines whether or not execution records of processing data are desired ones based on the positions of detected commands in the programs obtained from the execution probes 21-1 to 21-m, the contents of processing data, past execution records, and given determination conditions.

The given determination conditions include, for example, the transport protocol number 6 (TCP), the destination port number of the transport protocol 5013, a destination IP address 192.168.1.15, processing requirements for the Network Layer such that ESP encapsulation is executed and a destination IP address of the outer header is 133.201.5.15. If all of the conditions are identified with reference to processing data or values of parameters, necessity of execution records can be determined. The determination conditions are defined by a user and stored in the determining unit 26.

The receiver 27 receives processing data from an external program. The deleting unit 28 deletes processing data after the processing data is output to an external program. Specifically, the receiver 27 prepares a free data buffer so that data is stored in the prepared data buffer 23 through a given interface. The deleting unit 28 outputs data stored in the data buffer 23 to an external program, and then changes the memory used as the data buffer 23 back to an unused state. When the deleting unit 28 deletes execution records which are stored in the data buffer 23 and determined to be necessary, the deleting unit 28 copies and stores the execution records in the storing unit 29.

The storing unit 29 stores execution records separately from processing data, and outputs the stored execution records to an external program. The analysis program 30 reads execution record data from the storing unit 29, and processes and analyzes the read data. The other program may include the analysis program 30.

Hereinafter, operations of the execution path analyzing system according to the first embodiment are explained.

How processing data is processed by a program other than the execution probe 21 is explained with an example where a communication device that executes packet exchange receives packets.

When a packet is received, interruption occurs from hardware, and an interruption handler and a device driver are sequentially called. The device driver inputs the packet as processing data to a memory. Specifically, the receiver 27 prepares a data buffer 23-i (i=1˜n) and stores the processing data in the data buffer 23-i. In the case of BSD/OS, m_devget( ) corresponds to this processing.

Usually, multiple data buffers 23 can be connected. If data cannot be stored in one buffer, the data is divided and stored in multiple buffers. Since each data buffer 23 has a given length, the data buffer 23 stores a start position and the amount of the data into the management region to specify where the data is stored in the data buffer 23. In the case of BSD/OS, mbuf corresponds to the data buffer.

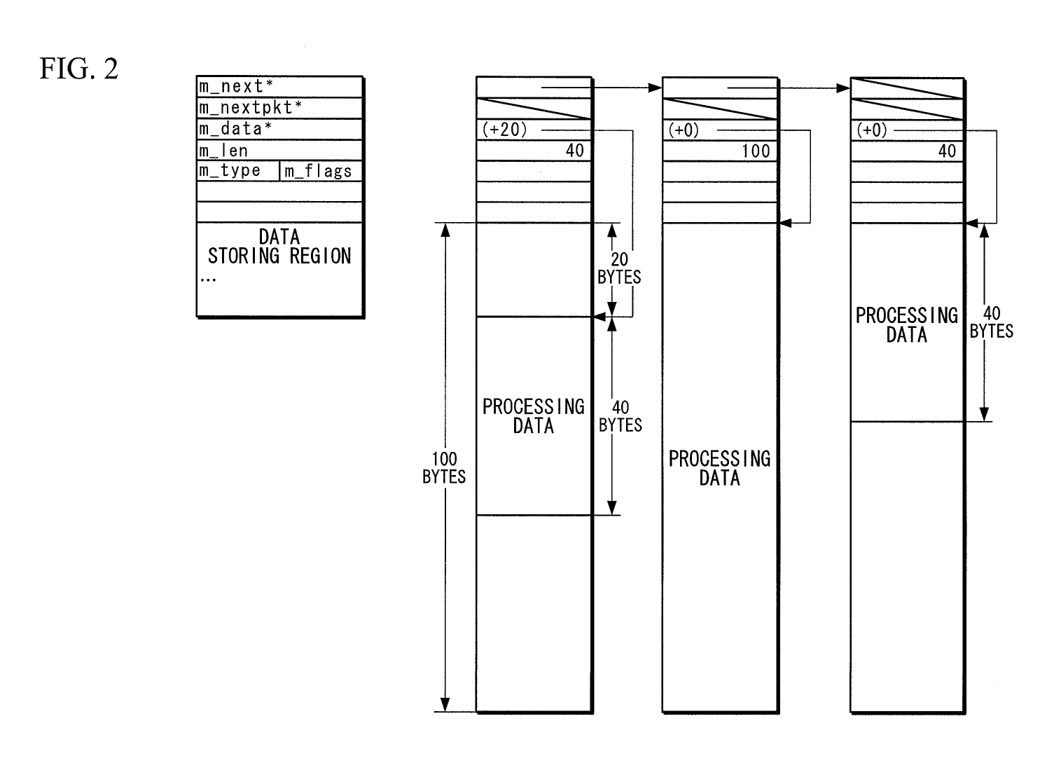

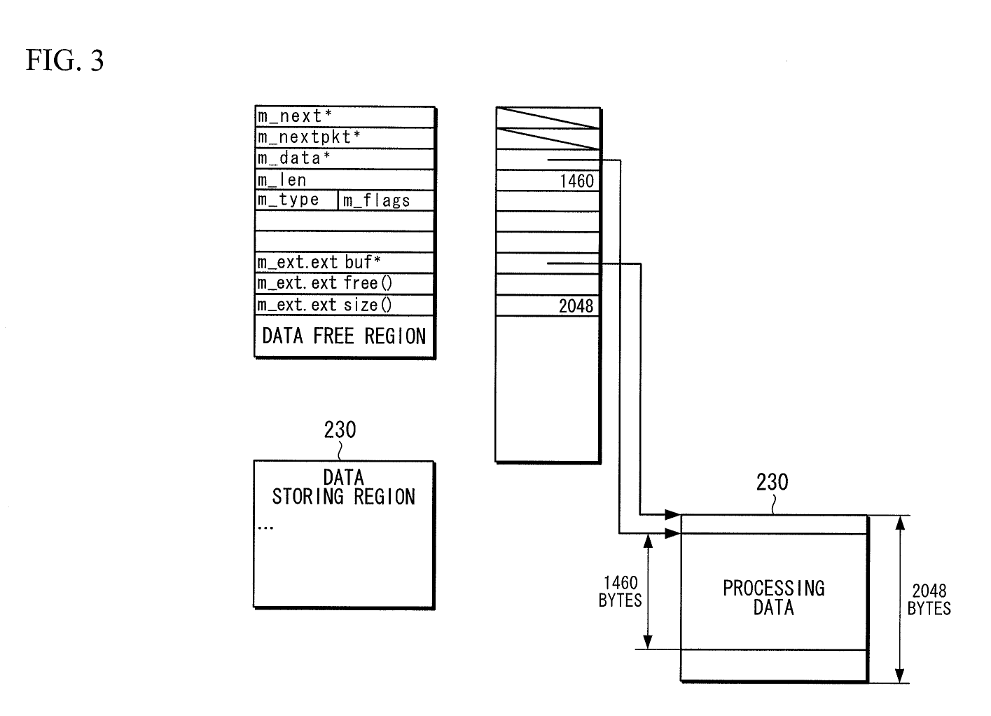

FIGS. 2 and 3 illustrate examples of mbuf. Data up to 100 bytes can be stored in one mbuf and multiple data buffers can be connected. This structure is suited to addition and removal of protocol header. If the data amount is small, data is stored as shown in FIG. 2. If the data amount is large, an external buffer called an mbuf cluster 230 is used as shown in FIG. 3. A similar buffer is used in another OS, such as sk_buff of Linux or msgb of an OS including Solaris SREAMS.

After processing data is stored in the data buffer 23, a program processes data in a given order. Although a process of the processing is not a primary subject of the present invention and therefore not explained here, the following protocol processes are generally executed.

One of the processes is to store a header of a protocol in one buffer. When processing data is stored in multiple data buffers 23, such as the case of mapping of data into a structure by type casting, data cannot be handled as continuous data. For this reason, data exchange and buffer recombination are executed according to need so that some data region is stored in one buffer. In the case of BSD/OS, m_pullup( ) corresponds to this operation.

Another process is to provide a free region in the head region of the data buffer 23 or remove data from the head region. Usually, protocol data includes multiple headers which are an upper layer header to a lower layer header sequentially added in this order to the head of a payload. These headers are sequentially removed upon reception and added to the head of a payload upon transmission. For this reason, operations of adding and removing data to and from the head of processing data are typical. In the case of BSD/OS, M_PREPEND( ) and m_adj( ) correspond to these operations.

After a program processes processing data, transfer of the processing data to another program or deletion of the processing data is generally executed. The received packets are finally processed by an application program. Packets to be transmitted are finally output to the device driver to be output to the hardware connected to a physical transmission path.

Generally, the other program 22 cannot use the data buffer 23 provided for the target program 20 for execution path analysis since a method of managing processing data and address space of memory differ. For this reason, an interface to which data is transferred is preliminarily defined, and data included in the data buffer is transferred through the interface. In the case of BSD/OS, copyout( ) is used to transfer data to an application (user process). Then, the data included in the buffer is not necessary, and therefore deleted. Thereby, the buffer changes to an unused state.

On the other hand, if resources are lacking, or data is abnormal so that processing cannot continue, the data is deleted instead of being transferred to the other program. Also in this case, the data buffer 23 changes back to an unused state.

In any cases, the buffer changes back to an unused state. In the case of BSD/OS, m_freem( ) corresponds to this processing.

Hereinafter, an operation by the execution probe 21 is explained. As explained above, while the target program 20 is executed, the execution probe 21 is executed by: directly inserting a command into a recording point in the target program 20 and executing the command; preparing the execution probe 21 as a subroutine and inserting a code for calling the subroutine into a recording point in the target program 20; or transferring control to a subroutine using debugging of a CPU (such as break point) without changing the target program 20.

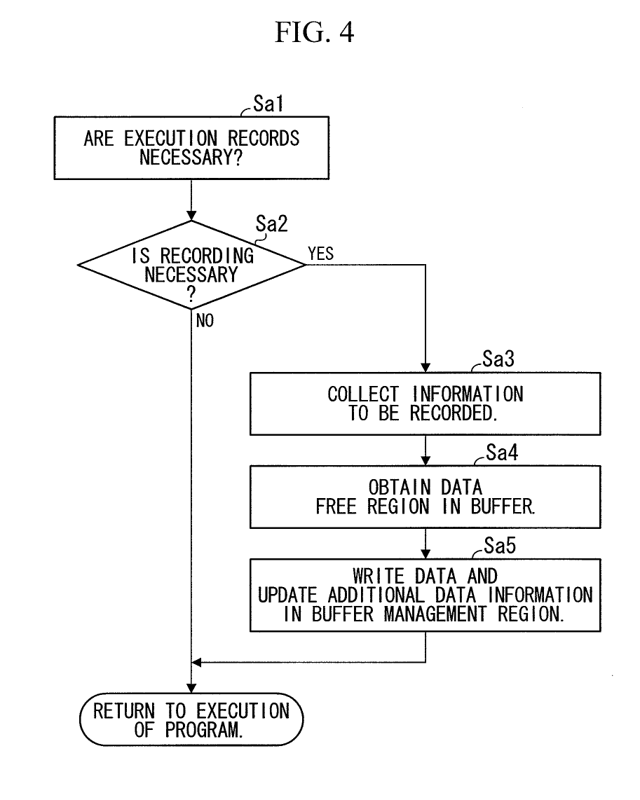

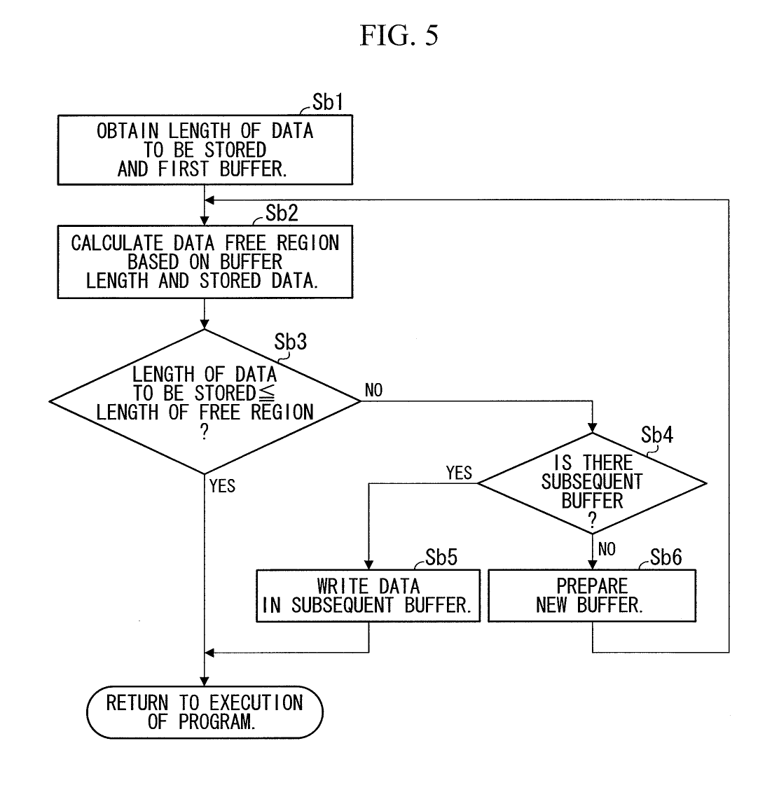

FIGS. 4 and 5 are flowchart illustrating operations by the execution probe 21. The execution probe 21 makes the determining unit 26 determine the necessity of execution records (step Sa1). More specifically, the execution probe 21 indicates stored positions of the program, processing data, and past execution records to the determining unit 26 so that the determining unit 26 determines the necessity of execution records. The determining unit 26 outputs information indicative of “necessary”, “unnecessary”, or “unknown” as a determination result. If the determination result is “necessary” or “unnecessary”, the execution probe 21 writes the determination result in an additional data region of the data buffer 23. If the determination result is “necessary” or “unknown”, the execution probe 21 writes execution records into the data buffer 23.

Then, the execution probe 21 determines whether or not recording is necessary (step Sa2). If recording is necessary (step Sa2: YES), the execution probe 21 collects information to be recorded as execution records. Since the type of information to be recorded is defined in the setting unit 25, the execution probe 21 refers to the setting unit 25 to collect the information. The execution probe 21 can preliminarily obtain, from the target program 20, information concerning the position of the detected command in the target program 20, the position of a memory storing data processed by the program, and values of parameters which are set at the position of the detected command which can be referred to in the program. The execution probe 21 preliminarily includes means for collecting information stored in the setting unit 25.

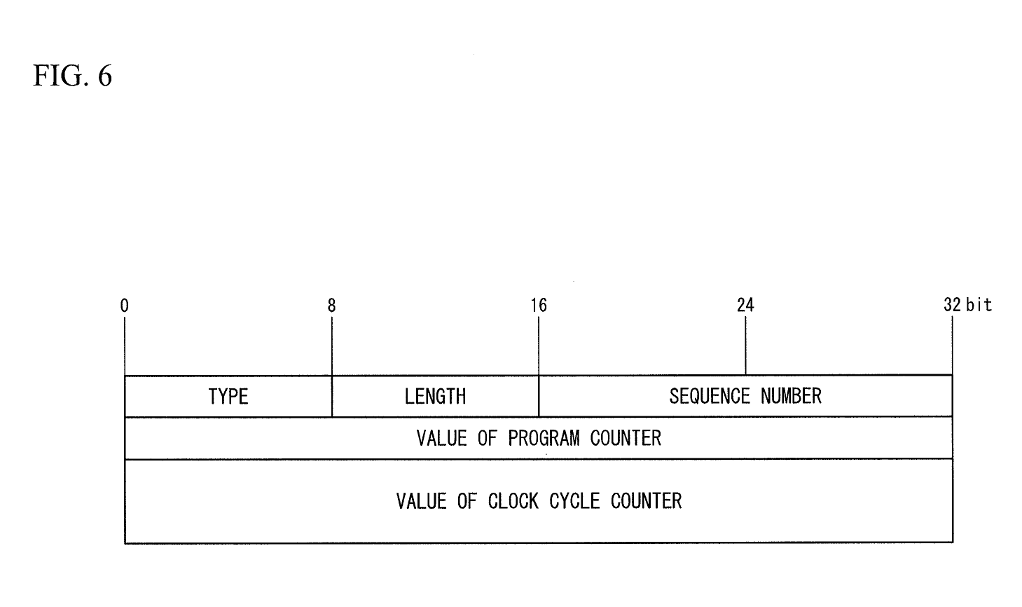

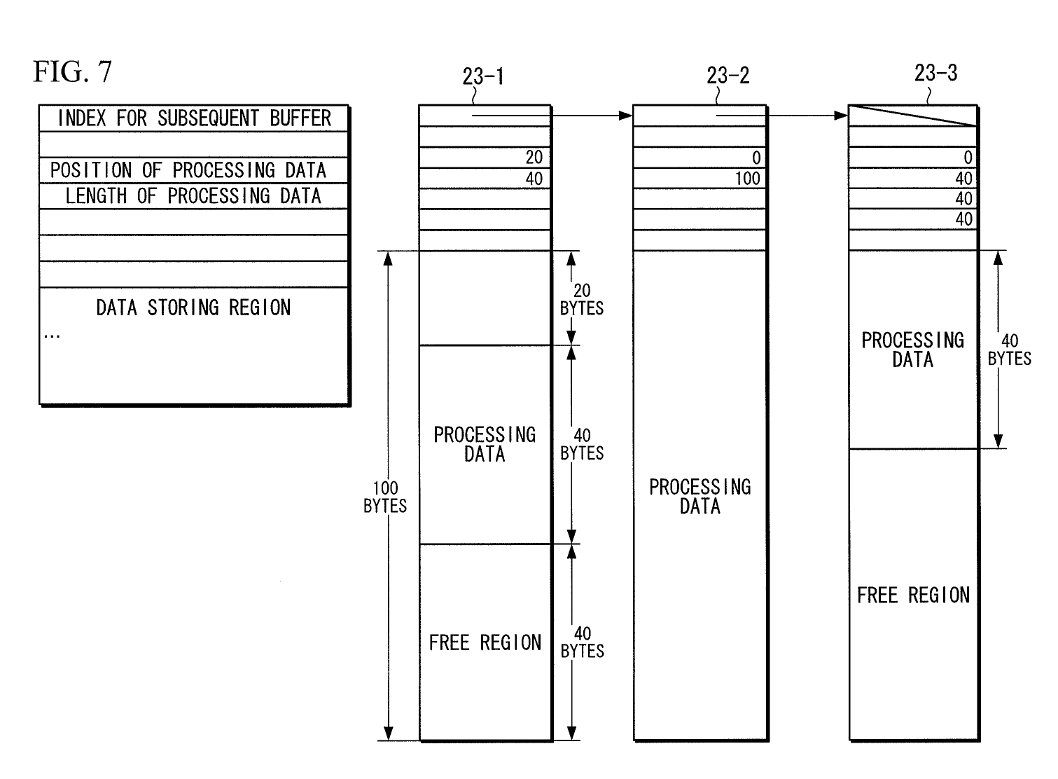

FIG. 6 illustrates typical and simple execution record data. “Type” denotes the type of execution records, “length” denotes the length of the execution records (the byte number), “sequence number” denotes the sequence number of the execution records, “program counter” denotes a value of a program counter when data passes through the execution probe, and “clock cycle counter” denotes a value of a clock cycle counter when data passes through the execution probe.

Specific data in the above format (hexadecimal dump) is, for example, “01 10 00 05 FE FF 30 54 00 00 00 00 01 04 E142” which indicates the type “01”, the length “10”, the sequence number “00 05”, the program counter “FE FF 30 54”, and the clock cycle counter “00 00 00 00 01 04 E1 42”.

Execution records in the data buffer can be sorted in the order of recording based on the sequence numbers. Which code included in the target program corresponds to each execution record is identified based on a value of the program counter. Based on a value of the clock cycle counter, the recording start time can be recorded with an accuracy of an operation clock of a CPU. Based on these pieces of information, execution records stored in processing data can be sorted so that the processing amount between execution points included in a program through which the processing data passes.

Then, the execution probe 21 prepares a storage region in the data buffer 23 (step Sa4), writes data therein, and updates management information (step Sa5). More specifically, the execution probe 21 determines whether or not a sufficient free region is present in the data buffer 23, i.e., whether or not collected information can be stored in the data buffer 23. In other words, the execution probe 21 checks if the data buffer 23 has a free region enough to store the collected execution records.

The simplest method is that lists of the data buffer 23 are checked from the beginning thereof, the lengths of regions before and after stored processing data are checked based on the start position and the length of the stored processing data, the start position and the length of the additional data is checked, and thereby the length of a free region can be obtained.

Hereinafter, the method of providing a free region is explained in detail with reference to FIG. 5. The execution probe 21 obtains the length of data to be stored and a first buffer (step Sb1), and calculates the size of a free region based on the buffer length and stored data (step Sb2).

It is assumed that there are data buffers 23 each storing processing data. In this case, the first data buffer 23-1 includes a free region of 40 bytes. The second data buffer 23-2 includes no free region. The third data buffer 23-3 includes a free region of 20 bytes. In this method, the order of positions of execution records in the buffer might not correspond to the order of recoding start time. If the order of recording start time has to be stored, for example, the sequence numbers are assigned to respective execution records. Additionally, the sequence number of the last recorded execution record and the position thereof in the data buffer 23 are stored in additional data positioned at the head of the data buffer 23. When a new execution record is stored, a free region is detected from the data buffer 23 storing the last recorded execution record.

Then, the execution probe 21 determines whether or not the length of data to be stored is equal to or less than the length of the free region (step Sb3). If the length of the data to be recorded is equal to or less than the length of the free region (step Sb3: YES), the execution probe 21 writes the data into the free region and updates management information in the management region. If the length of the data to be recorded is greater than the length of the free region (step Sb3: NO), the execution probe 21 determines whether or not a subsequent data buffer 23 is present (step Sb4). If a subsequent data buffer 23 is present (step Sb4: YES), the execution probe 21 writes the data in the subsequent buffer 23 (step Sb5) similarly to step Sa5.

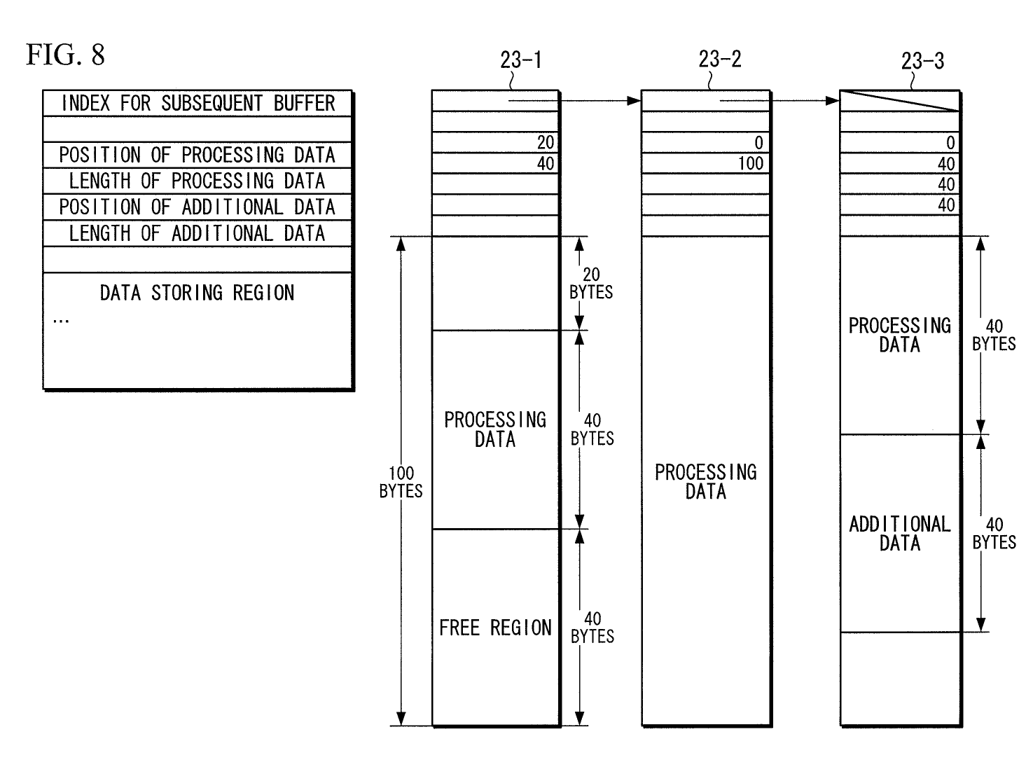

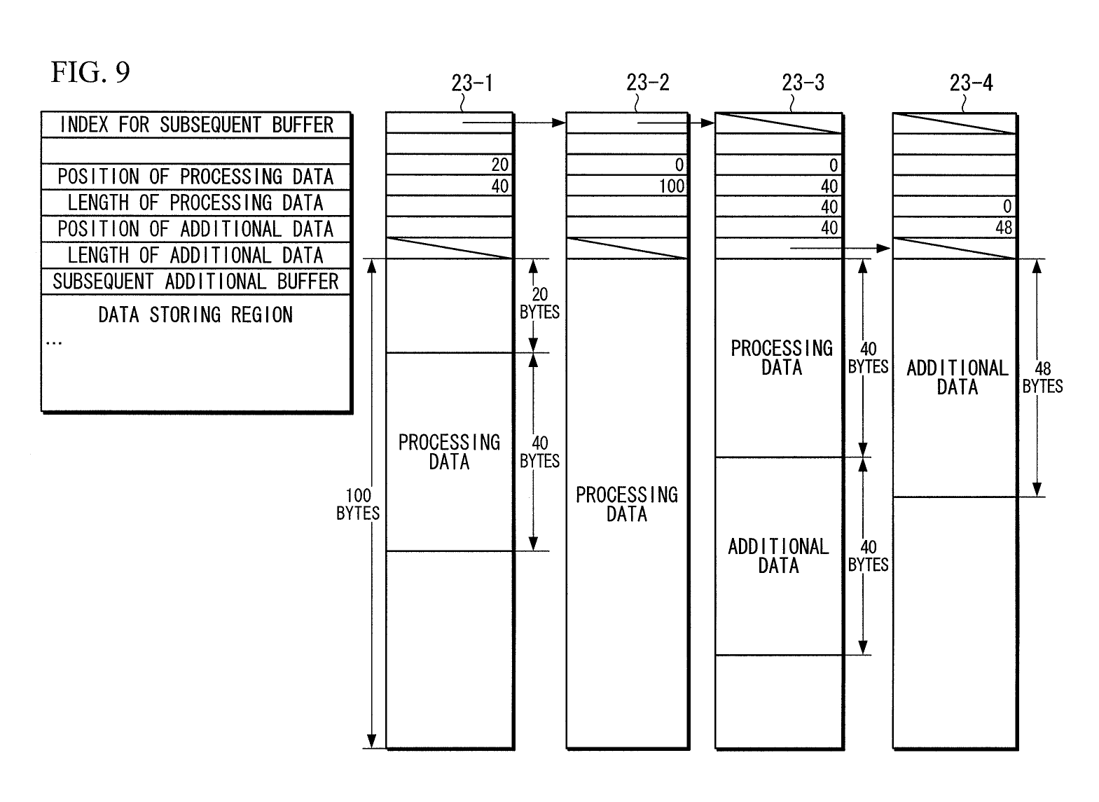

If a subsequent buffer 23 is not present (step Sb4: NO), the execution probe 21 prepares a new data buffer 23 (step Sb6). A new data buffer 23 is prepared in a same manner as executed by the receiver 27. Then, the execution probe 21 writes execution records in the new data buffer 23 and updates management information of the new data buffer 23, followed by connecting the new data buffer 23 to the last data buffer storing processing data. FIG. 8 illustrates the case where the first data buffer 23-1 includes a free region of 40 bytes, the second data buffer 23-2 includes no free region, and the third data buffer 23-3 includes a free region of 20 bytes. If execution records of 48 bytes are to be stored, any of the data buffers 23-1, 23-2, and 23-3 includes no sufficient region enough to store the execution records of 48 bytes. In this case, the execution probe 21 connects the fourth data buffer 23-4 to the third data buffer 23-3 to store the execution records.

Hereinafter, operation of releasing a data buffer is explained.

The case of deleting only processing data stored in a specific data buffer 23, such as the case of deleting only a specific protocol header, is explained hereinafter. The data buffer 23 storing processing data to be deleted becomes unnecessary, and therefore removed from the buffer lists. If execution records are stored in the data buffer 23 to be removed, the execution records are transferred to a data buffer 23 storing the processing data or a data buffer 23 connected to the data buffer 23 to be removed. At this time, a free region of the data buffer 23 is checked similarly to the aforementioned process of writing execution records. If a free region is present, the execution records are written therein. If a free region is not present, the data buffer 23 from which processing data is deleted so as to include only additional data is connected to the last data buffer.

The case of deleting all processing data, such as the case of transferring processing data to the other program 22 and finishing the processing of data, or the case where processing cannot continue, is explained hereinafter. In this case, the execution prove 21 determines whether or not backup of additional data stored in the data buffer 23 is necessary. Only if backup of the additional data is necessary, the execution probe 21 copies the additional data to the storing unit 29 and deletes all data stored in the data buffer 23.

In this manner, execution records at execution points in a program where the execution probe 21 is inserted can be retained in processing data from when the processing data is received by the program to when the processing data is deleted therefrom.

When the necessity of storing execution records is determined during data processing, execution records are retained in processing data. Thereby, the necessity of storing execution records can be identified for each processing data later.

Further, when processing data is deleted, only necessary execution records are stored in the storing unit 29. Thereby, only execution records for desired processing data can be stored.

### Second Embodiment

Hereinafter, a second embodiment of the present invention is explained.

In the first embodiment, execution records are always stored in the storing unit 29, and a program that uses the execution records has to obtain the execution records from the storing unit 29 separately. This process has a merit in that all necessary execution records can simultaneously be obtained, but has the following demerits.

One of the demerits is in that execution records cannot quickly be obtained when storing of execution records for processing data is completed. Another of the demerits is in that the program that reads the execution records has to correlate the processing data and the execution records, if necessary.

To solve these problems, it is preferable for a program for transmitting and receiving processing data to simultaneously execute reading of execution records and reading and writing of processing data. In the case of recvmsg system call of Berkeley Socket API, additional data can be transferred in the control data field of an msghdr structure. By transferring execution records using this function, processing data and execution records can simultaneously be read out. Therefore, the process of reading data from a buffer can be omitted.

Additionally, a pointer to the data buffer 23 for writing execution records is transferred by an API argument upon writing. In a program, pointers to the data buffer 23 may be stored therein as additional data for transmission data, so that execution records are output to the corresponding data buffer 23 upon data transmission.

### Third Embodiment

Hereinafter, a third embodiment of the present invention is explained.

Explanations of the first and second embodiments have been given assuming that packets received from an external program are basically output to another external program though headers of the packets are partially removed or added. This process is common in a communication system using packet exchange. In steaming services based on TCP, however, segmentation or connection of processing data is executed for efficient data transmission.

Particularly, if multiple processing data items are connected, it is necessary not to mix execution records for each processing data item. In the third embodiment, handling of execution records in the case where connection and segmentation of processing data are executed, such as the case of TCP.

When processing data is segmented, respective segmented data items might be processed on different paths. To record execution records without any problem in this case, execution records may be included in the respective segmented processing data items. However, if recoding is not necessary, this process is not necessary. Therefore, the following two cases can be considered.

If recoding is not necessary, execution records are deleted. Otherwise, execution records are copied and added to each of segmented processing data. Thus, each of the segmented processing data can independently retain execution records.

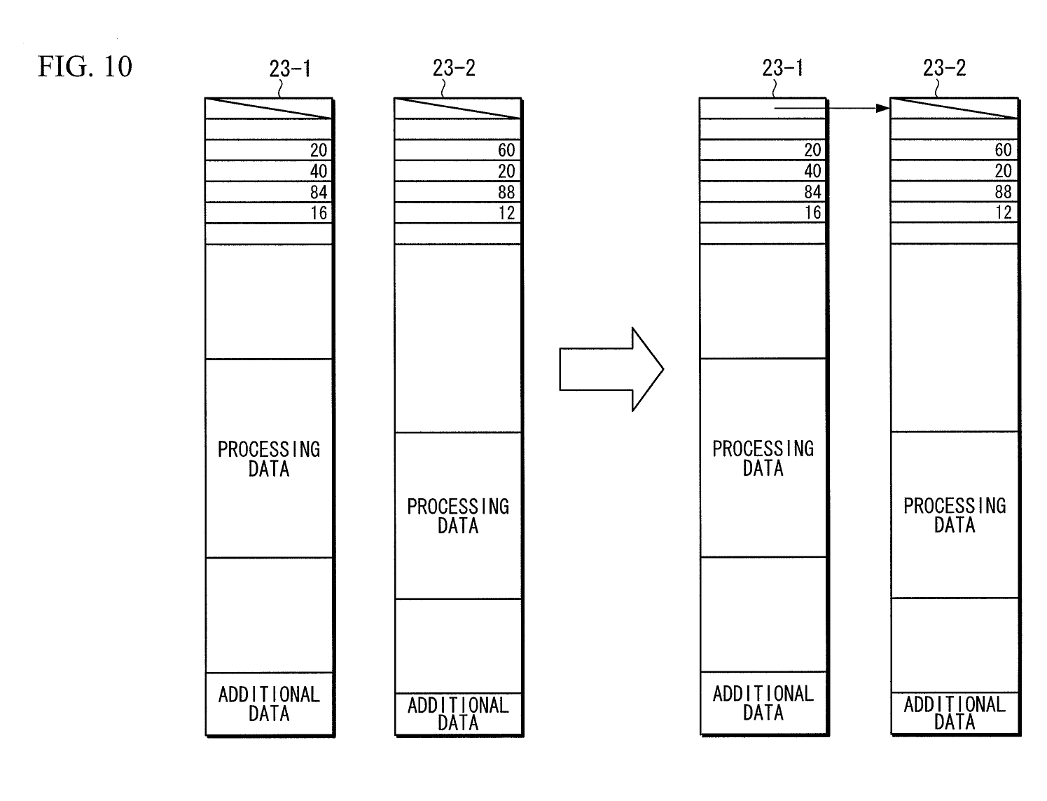

FIG. 10 illustrates connection of processing data items according to the third embodiment. In the case of connecting processing data items, multiple data items that have been processed on different paths are connected as one data item, and processing continues with respect to the connected data regarded as one data. In many cases, the degree of degradation of memory efficiency caused by transfer of data is much greater than that of improvement in memory efficiency caused by repackaging of data. For this reason, data stored in the data buffers 23-1 and 23-2 are not transferred, and only connection lists of the data buffers 23-1 and 23-2 are updated. Consequently, execution records do not usually need to be transferred upon connection of processing data items.

Here, the following conditions have to be satisfied. The first condition is not to mix execution records before connection of processing data items. The second condition is to efficiently store execution records after connection of processing data items. The third condition is to determine the necessity of execution records.

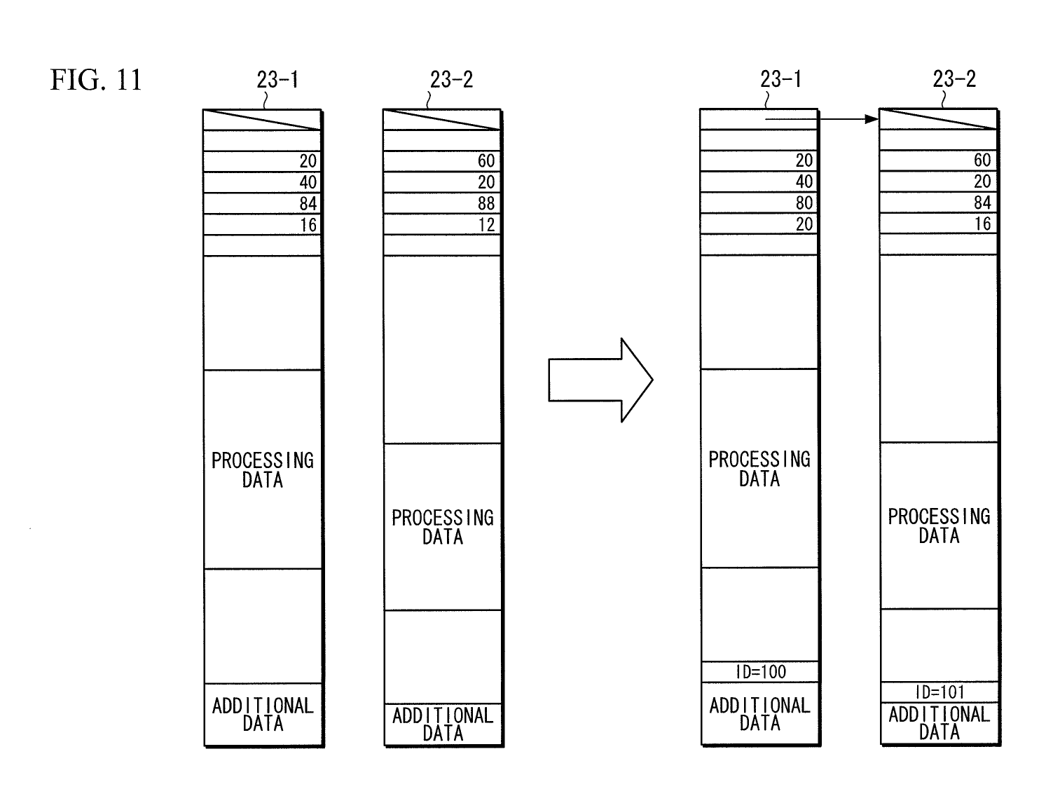

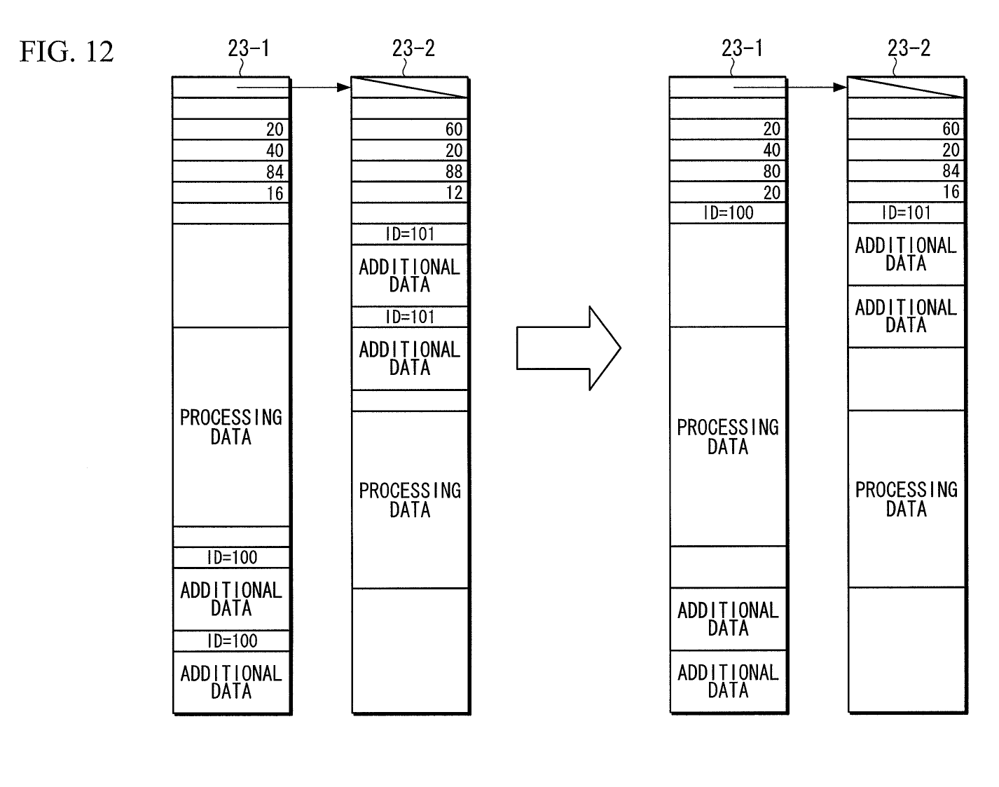

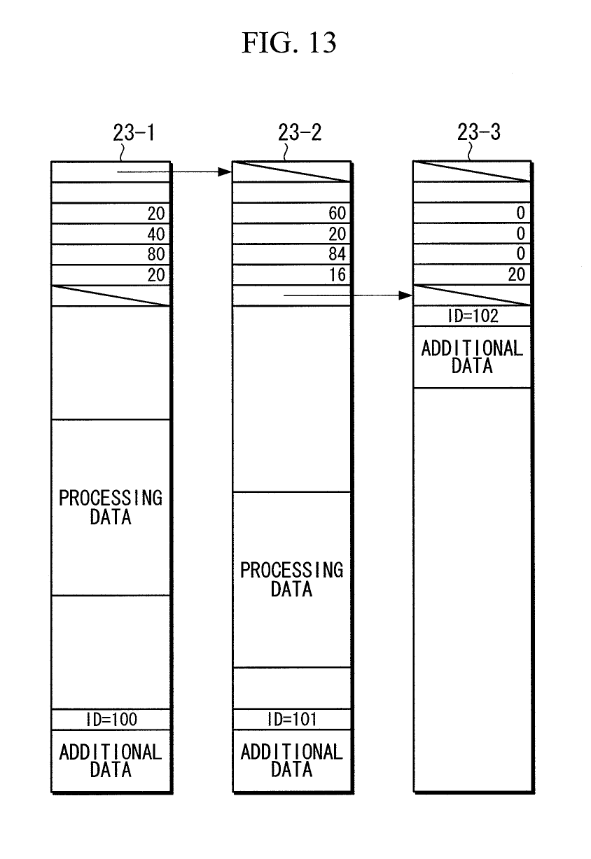

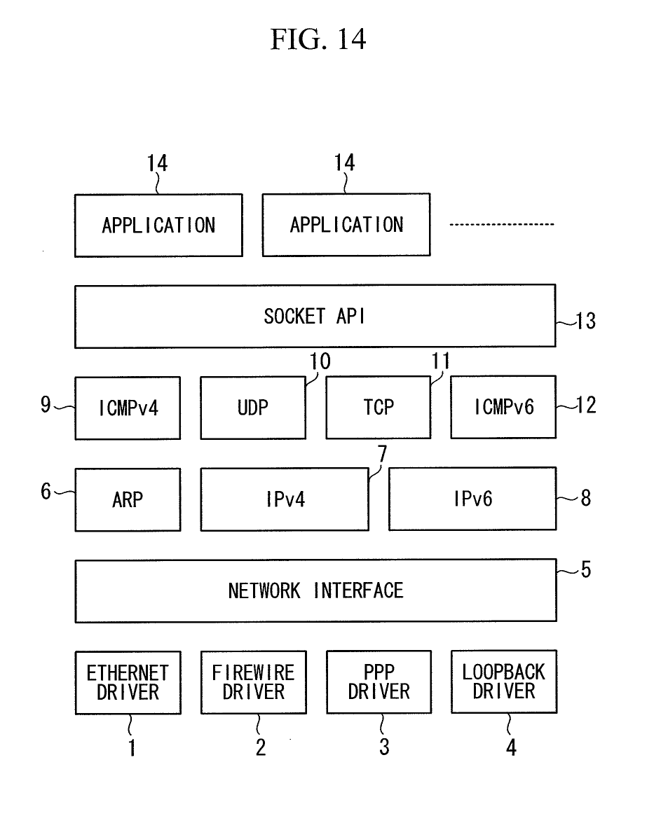

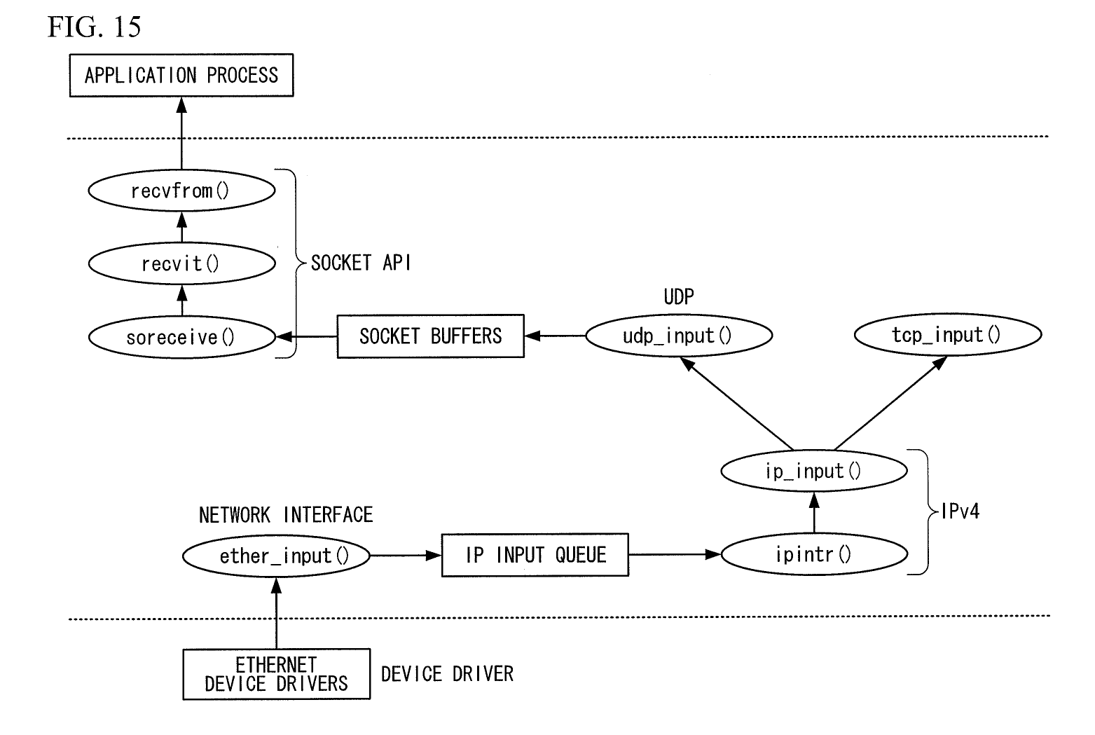

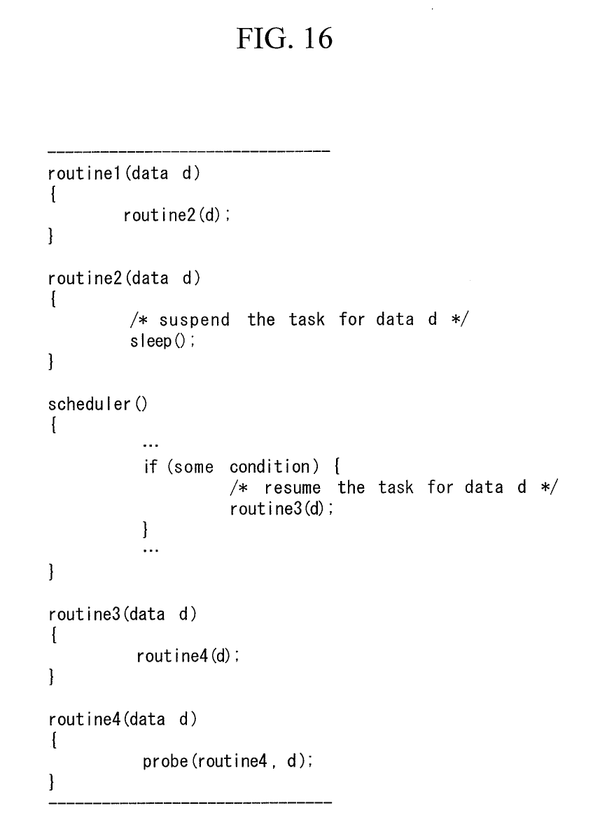

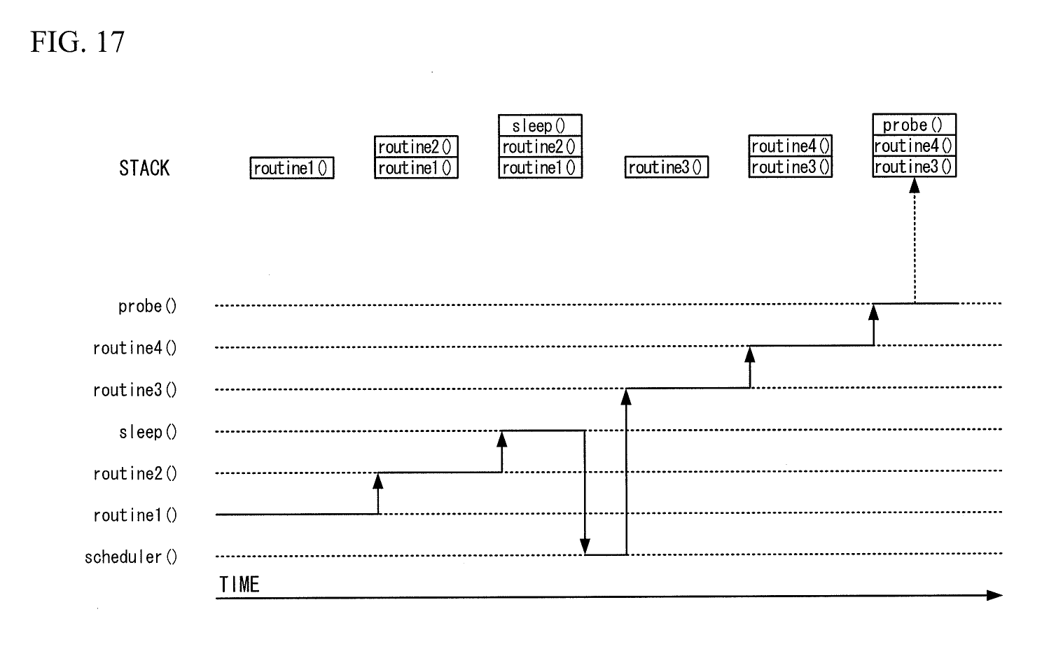

The first condition is satisfied by setting an identifier to each execution record. As shown in FIG. 11, different identifiers IDs=100 and 101 are added to two processing data items input from different sources so that the two processing data items are not mixed. Since it is not efficient to add an identifier to each execution record, identifiers IDs=100 and 101 may be respectively added to the data buffers 23-1 and 23-2 if execution records are independently stored in the data buffers 23-1 and 23-2, as shown in FIG. 12.

When it is necessary to identify which part of processing data each execution record corresponds to, the start offset and the length of target data may be retained in each execution record to identify which part of processing data each execution record corresponds to even after connection of processing data items.

Regarding the second condition, execution records before connection and execution records after connection are distinguished by identifiers, and only the execution records after the connection are stored, thereby preventing rewriting of execution records.

Regarding the third condition, it is necessary not to record unnecessary information and lose necessary information upon connecting a processing data item including necessary execution records and a processing data item including unnecessary execution records. The execution records determined to be unnecessary before connection of processing data items may be deleted. On the other hand, if execution records determined to be necessary before connection of processing data items are present, execution records after the connection are also necessary. Accordingly, even if other execution records that cannot be determined to be necessary are present, execution records after the connection may be regarded as necessary.

If only execution records which cannot be determined to be necessary are present, execution records after the connection are regarded as “unknown” and the determining unit has to continue necessity determination afterward. If the determining unit uses execution records for determination, it has to be considered that execution records from different transmission paths are mixed after connection of processing data items. In other words, execution records before connection of processing data items and execution records after connection of processing data items are treated as one continuous data, necessity determination is executed for every transmission path. If at least one execution record from one transmission path determined to be necessary is present, these execution records are treated as necessary.

According to the present invention, bugs can easily be detected upon development of a program to be mounted on, for example, a communication device, and development cost and development period can be reduced. Therefore, a communication device can be provided with low cost and short period. Further, a higher-performance communication device can be provided with low cost and short period since operation conditions of the program are checked and a problem on performance can easily be detected.

It is apparent that the present invention is not limited to the above embodiments, but may be modified and changed without departing from the scope and spirit of the invention.

What is claimed is:

1. An apparatus that analyzes execution paths of a target program, comprising:
a setting unit that stores a condition for determining whether or not to record events caused by execution of the target program;
a detecting unit that detects input and output data and events which are caused by execution of the target program;
a determining unit that determines whether or not to record the events based on the condition; and
a plurality of buffers that store the events correlated with the input and output data if the determining unit determines to record the events.

2. The apparatus according to claim 1, wherein
the buffers comprise a first buffer and a second buffer, and
the apparatus further comprises a controller that stores the events correlated to the input and output data into the first buffer during execution of the target program, and stores the input and output data determined to be necessary into the second buffer upon deletion of the input and output data.

3. The apparatus according to claim 1, further comprising
a controller that, if the input and output data is segmented, copies the events and stores the segmented input and output data into the buffers, each of the segmented input and output data being correlated with the copied events.

4. The apparatus according to claim 1, further comprising
a controller that, if a plurality of input and output data are combined, connects the buffers to respectively store the plurality of input and output data into the buffers without transferring each of the plurality of input and output data among the buffers.

5. A method of analyzing execution paths of a target program, comprising:
storing a condition for determining whether or not to record events caused by execution of the target program;
detecting input and output data and events which are caused by execution of the target program;
determining whether or not to record the events based on the condition; and
storing the events correlated with the input and output data into a plurality of buffers if the determining unit determines to record the events.
